(19) United States
(12) Patent Application Publication
(10) Pub. No.: US 2003/0194534 A1
(43) Pub. Date: Oct. 16, 2003

(54) Anti-moisture floor tile

(76) Inventor: Chen-Chi Mao, Taipei (TW)

Correspondence Address: BACON & THOMAS, PLLC, 625 SLATERS LANE, FOURTH FLOOR, ALEXANDRIA, VA, 22314

(21) Appl. No.: 10/118,992

(22) Filed: Apr. 10, 2002

(51) Int. Cl. B32B 3/00

(52) U.S. Cl. 428/156

(57) ABSTRACT

A type of floor tile, provided with the bottom surface as a ragged surface, wherein the ragged surface is possibly a pressed embossment, or a ragged depth formed by coating with the self adhesive partially. By coating with the adhesive on the bottom of the raised surfaces of the ragged surface for the floor tile, or by the adherence of the self adhesive, the bottom of the floor tile is not entirely adhered with the floor, and by forming a conduit for moisture on the floor with the ragged bottom surface after adhesion, the effect for anti-moisture can be achieved.

### BACKGROUND OF THE INVENTION

1. Field of the Invention

A type of floor tile, particularly with the surface attached to the floor being ragged, and coating with adhesive on the raised portion of the ragged surface.

2. Description of the Background Art

For the conventional tile, rock floor tile, the surfaces attached to the floor are configured with structures, such as pressed embossment or raised points, but the usage is to enlarge the contact area with the adhesive so that the floor tile can be robustly adhered on the floor. Such a method is just like the way for applying the wall tile on the wall that the wall will normally be treated rougher or be knocked with thick pits. The conventional working method for the floor tile would occur a phenomenon after pavement of the floor tile, that if the environment is rather moisty, the moisture on the floor would raise upward. The surface of the floor tile, such as the tile or rock floor tile, is usually provided with capillaries to exhaust the moisture. But the plastic floor tile is usually made of waterproof material which can not exhaust the moisture from the surface of the floor tile, so that the moisture may be kept in the floor, and the moisture will induce a chemical reaction with the adhesive for adhering the floor tile with the floor in the long run. Therefore, the adhesive function will be failed and the floor tile will progressively be dismantled from the floor. This is the reason why the plastic floor tile is not suitable for applying in a too moisty environment.

### SUMMARY OF THE INVENTION

The reason that the plastic floor tile can not be securely paved in the moisty environment over a long period of time is that the waterproof material can not effectively exhaust the moisture. The improvement for the moisture is not an only way by completely exhausting the moisture, but with a canalizing method like the method used by Yu the Great for regulating the flood. The present invention provides a plastic floor tile structure which can effectively canalize the moisture in an environment preventing from the accumulation on the bottom of the floor tile destroying the adhesion of the adhesive. The object of the invention is to provide a plastic floor tile with the bottom surface contacted to the floor having a ragged surface. The formation of the ragged shape can be directly pressed with a ragged embossment during the manufacturing for the floor tile, or by coating with an adhesive to a certain depth partially on the bottom of the plastic floor tile. If the above-mentioned pressing embossment method is used, the adhesive would be coated on the raised ends of the embossed surface, and the raised surface with the coated adhesive is attached with the floor so as to form a gap for gas flowing between the bottom of the floor tile and the attached floor. Thus, the moisture generated on the floor and raised there from will freely flow through these gaps and be exhausted from the connection gaps between the floor tiles. The method is characterized that the moisture may not be kept at the bottom of the floor tile so as not to induce the chemical reaction with the adhesive resulting in the adhesion failure for the adhesive. Therefore, such a structure can make the plastic floor tile securely paved in a moisty environment over a long period of time.

### BRIEF DESCRIPTION OF THE DRAWINGS

FIG. 1 is a partially cross-sectional view of the present invention;

FIG. 2 is a partially enlarged view of FIG. 1;

FIG. 3 is a cross-sectional view according to another embodiment of the present invention.

### DESCRIPTION OF THE PREFERRED EMBODIMENTS

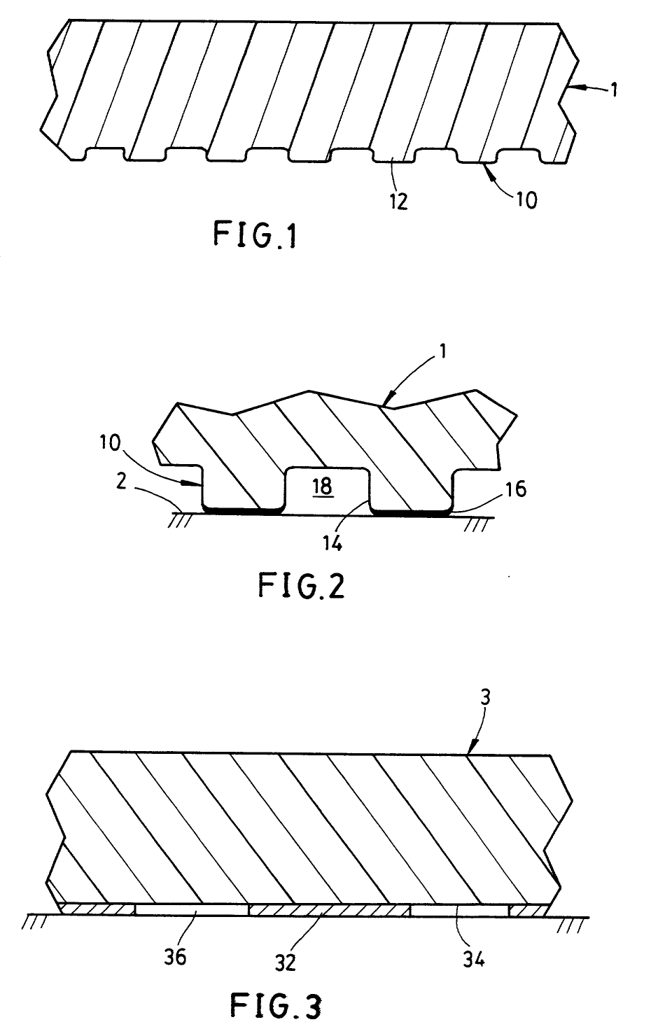

A type of floor tile according to the invention is shown as FIGS. 1 and 2. As a normal plastic floor tile, such as the foaming plastic floor tile, the printed adhesive floor tile, the bottom is formed as a ragged surface 10. The ragged surface 10 may be a cross-section 12 as shown in the figure, and also possibly be of any regular shape or irregular shape, and of continuous or discontinuous cross-section. The downward raised surface 14 on the ragged surface 10 is coated with the adhesive 16 in advance, in which the type of the adhesive 16 is preferably a type of pressure-sensitive glue for repeatedly detachable function for the floor tile. The floor tile 1 is adhered on the floor 2 by the adhesive 16, and in a view of the cross-section after the adhesion, the floor tile 1 and the floor 2 exhibit gaps 18 in-between by the ragged surface 10. With the plurality of gaps 18 in presence at the bottom of the floor tile 1, the moisture generated from the floor 2 may be flowing within the space that it will not be accumulated between the floor 2 and the adhesive 16 for chemical reaction with the adhesive 16 and causing the adhesion failure for the adhesive 16.

The present invention can not only form the above-mentioned embossment on the ragged surface 10 at the bottom of the floor tile, but also provide another method for forming the ragged surface, which is to coat the adhesive 32 on the planar surface of the floor tile 3. The coating for the adhesive 32 is applied partially, that is, by partially coating with the adhesive 32 but others not. And, the adhesive 32 must at least have a certain depth, such as above 0.5 mm, so that the height difference between the formed coating depth and the bottom 34 of the floor tile 3 is formed as the desired gap 36 in the present invention. The invention uses the method for coating the bottom of the floor tile with the adhesive, wherein the coating area can be regular or irregular and the coating path may be continuous or discontinuous.

What is claimed is:

1. An anti-moisture floor tile, specifically an anti-moisture plastic floor tile, in which the bottom surface is a ragged surface, or a ragged glue surface formed by partially coating with the self adhesive to a certain depth, and the ragged surface or the raised bottom of the ragged glue surface is formed as an adhesive junction surface.

2. An anti-moisture floor tile as set forth in claim 1, wherein the ragged surface or the ragged glue surface is a regular ragged shape.

3. An anti-moisture floor tile as set forth in claim 1, wherein the ragged surface or the ragged glue surface is an irregular ragged shape.

4. An anti-moisture floor tile as set forth in claim 1, wherein the coating path of the ragged glue surface is continuous.

5. An anti-moisture floor tile as set forth in claim 1, wherein the coating path of the ragged glue surface is discontinuous.
